(19) United States
(12) Patent Application Publication
(10) Pub. No.: US 2025/0284509 A1
(43) Pub. Date: Sep. 11, 2025

(54) CULTURALLY-INTELLIGENT METAVERSE

(71) Applicant: INTERNATIONAL BUSINESS MACHINES CORPORATION, Armonk, NY (US)

(72) Inventors: Dong Chen, Beijing (CN); Ming Lei Zhang, Beijing (CN); Yuan Jie Zhang, Ningbo (CN); Yin Xi Guo, Hai Dian District (CN); Ting Ting Zhan, Beijing (CN)

(21) Appl. No.: 18/601,273

(22) Filed: Mar. 11, 2024

(51) Int. Cl. G06F 9/451

(52) U.S. Cl. CPC G06F 9/454

(57) ABSTRACT

A computer-implemented process for generating a modified scene using a culturally-intelligent platform having a dynamic library includes the following operations. A scene associated with a particular user is received in real-time. The scene is processed in real-time to identify participants associated with the scene. Intelligent recognition performed on the scene to identify a cultural item within the scene in real-time and using the dynamic library. The scene is modified based upon a description of the identified cultural item within the dynamic library to generate a modified scene that includes the description. A usefulness of the identified cultural item is determined, and an entry in the dynamic library associated with the particular user regarding the usefulness of the identified cultural item is updated based upon the scene being modified for the particular user.

### BACKGROUND

The present invention relates to the metaverse, and more specifically, to analyzing cultural items in a metaverse scene and modifying the scene based upon the analysis.

The metaverse is generally recognized as a network of shared 3D experiences that blur the divide between the digital world and the physical world. Typically, the metaverse is accessed using Extended Reality (XR), which is an umbrella term used to describe a number of related, albeit different technologies used to augment human senses. These technologies include augmented reality (AR), virtual reality (VR), and mixed reality (MR). AR typically involves overlaying digital elements onto a real world view. In other words, a real world view (e.g., a still photo or video) is altered to include additional digital elements that have some perceived relationship with the real world view. VR typically involves the creation of an immersive completely digital environment that can be viewed and interacted with by a user. In MR, aspects of both AR and VR are mixed. These technologies are typically device dependent. For example, a smartphone can be used with AR whereas VR typically requires a head mounted display/headset. MR devices can include transparent wearable glasses that present an overlay of digital content that interacts with real word objects in real-time. As used herein, the term “XR device” or “XR system” refers to a particular computer-implemented hardware device including one or more of AR, VR, and MR technologies.

### SUMMARY

A computer-implemented process for generating a modified scene using a culturally-intelligent platform having a dynamic library includes the following operations. A scene associated with a particular user is received in real-time. The scene is processed in real-time to identify participants associated with the scene. Intelligent recognition performed on the scene to identify a cultural item within the scene in real-time and using the dynamic library. The scene is modified based upon a description of the identified cultural item within the dynamic library to generate a modified scene that includes the description. A usefulness of the identified cultural item is determined, and an entry in the dynamic library associated with the particular user regarding the usefulness of the identified cultural item is updated based upon the scene being modified for the particular user.

In other aspects of the process, the usefulness is determined based upon comparing a usefulness value for the identified cultural item to a threshold value. Additionally, the usefulness value is based upon a base usefulness value for the identified cultural item, and decreases based upon an increased number of instances in which the scene is modified based upon the identified cultural item. The identified cultural item is a visual object displayed within the scene or a human gesture displayed within the scene. The scene is a computer data structure that represents a particular environment in which the users interact. The intelligent recognition employs machine learning to identify the cultural items.

A computer hardware system for generating a modified scene using a culturally-intelligent platform having a dynamic library includes a hardware processor configured to perform the following executable operations. A scene associated with a particular user is received in real-time. The scene is processed in real-time to identify participants associated with the scene. Intelligent recognition performed on the scene to identify a cultural item within the scene in real-time and using the dynamic library. The scene is modified based upon a description of the identified cultural item within the dynamic library to generate a modified scene that includes the description. A usefulness of the identified cultural item is determined, and an entry in the dynamic library associated with the particular user regarding the usefulness of the identified cultural item is updated based upon the scene being modified for the particular user.

In other aspects of the system, the usefulness is determined based upon comparing a usefulness value for the identified cultural item to a threshold value. Additionally, the usefulness value is based upon a base usefulness value for the identified cultural item, and decreases based upon an increased number of instances in which the scene is modified based upon the identified cultural item. The identified cultural item is a visual object displayed within the scene or a human gesture displayed within the scene. The scene is a computer data structure that represents a particular environment in which the users interact. The intelligent recognition employs machine learning to identify the cultural items.

A computer program product includes a computer readable storage medium having stored therein program code for generating a modified scene. The program code, which when executed by a computer hardware system including a culturally-intelligent platform having a dynamic library, cause the computer hardware system to perform the following. A scene associated with a particular user is received in real-time. The scene is processed in real-time to identify participants associated with the scene. Intelligent recognition performed on the scene to identify a cultural item within the scene in real-time and using the dynamic library. The scene is modified based upon a description of the identified cultural item within the dynamic library to generate a modified scene that includes the description. A usefulness of the identified cultural item is determined, and an entry in the dynamic library associated with the particular user regarding the usefulness of the identified cultural item is updated based upon the scene being modified for the particular user.

In other aspects of the computer program product, the usefulness is determined based upon comparing a usefulness value for the identified cultural item to a threshold value. Additionally, the usefulness value is based upon a base usefulness value for the identified cultural item, and decreases based upon an increased number of instances in which the scene is modified based upon the identified cultural item. The identified cultural item is a visual object displayed within the scene or a human gesture displayed within the scene. The scene is a computer data structure that represents a particular environment in which the users interact. The intelligent recognition employs machine learning to identify the cultural items.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1A is a block diagram of a culturally-aware metaverse architecture according to an aspect of the present invention.

FIG. 1B is a block diagram further illustrating the architecture of a culturally-intelligent platform according to an aspect of the present invention.

FIG. 2 illustrates a scene on a XR system.

FIGS. 3A, 3B respectively illustrate a methodology of employing the culturally-intelligent platform of FIG. 1B to generate cultural item object instances and employing the same to generated a modified scene according to an aspect of the present invention.

FIG. 4 illustrates a cultural item object instance according to an aspect of the present invention.

FIG. 5 illustrates a data structure including cultural object instances according to an aspect of the present invention.

FIGS. 6A and 6B respectively illustrates alternative approaches to modifying a scene according to an aspect of the present invention.

FIG. 7 is a block diagram illustrating an example of computer hardware system for implementing the culturally-intelligent platform of FIGS. 1A and 1B.

FIG. 8 is a block diagram illustrating an example computer hardware system for implementing the XR system of FIG. 1A.

### DETAILED DESCRIPTION

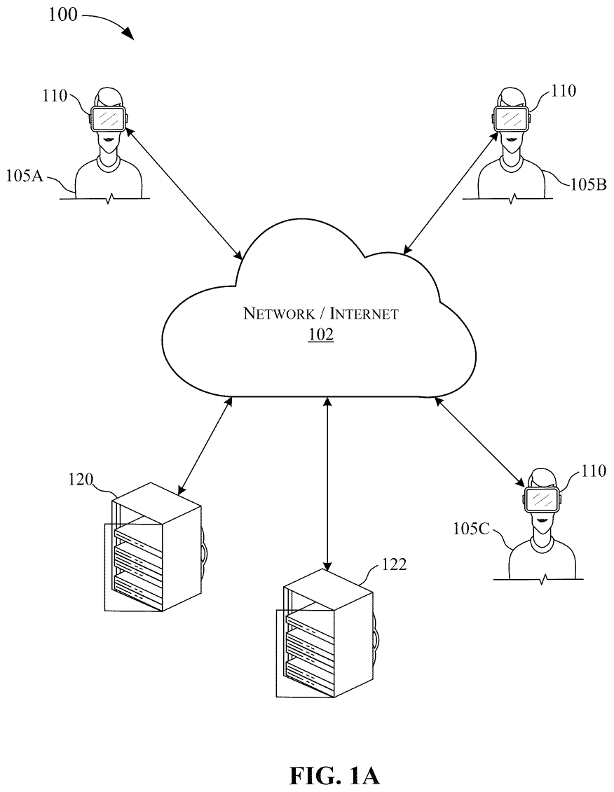

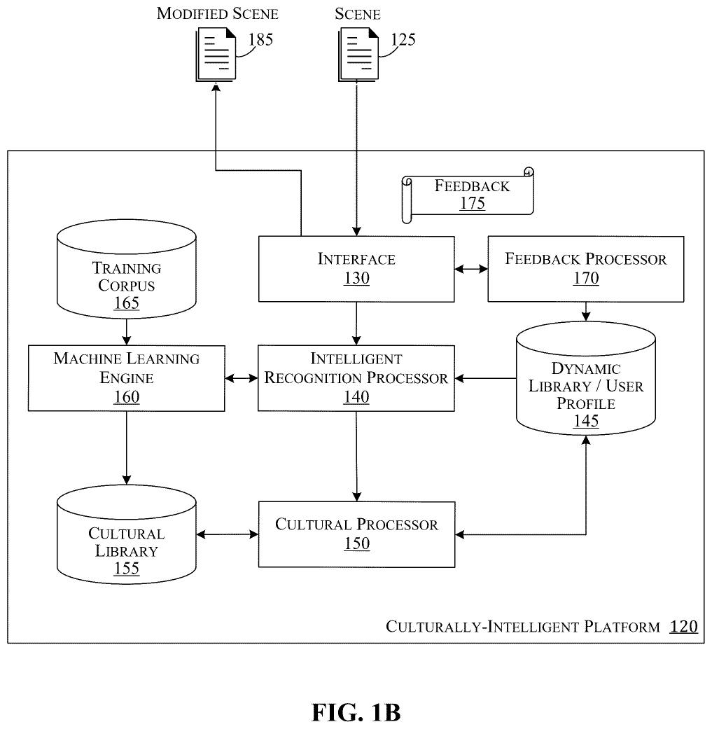

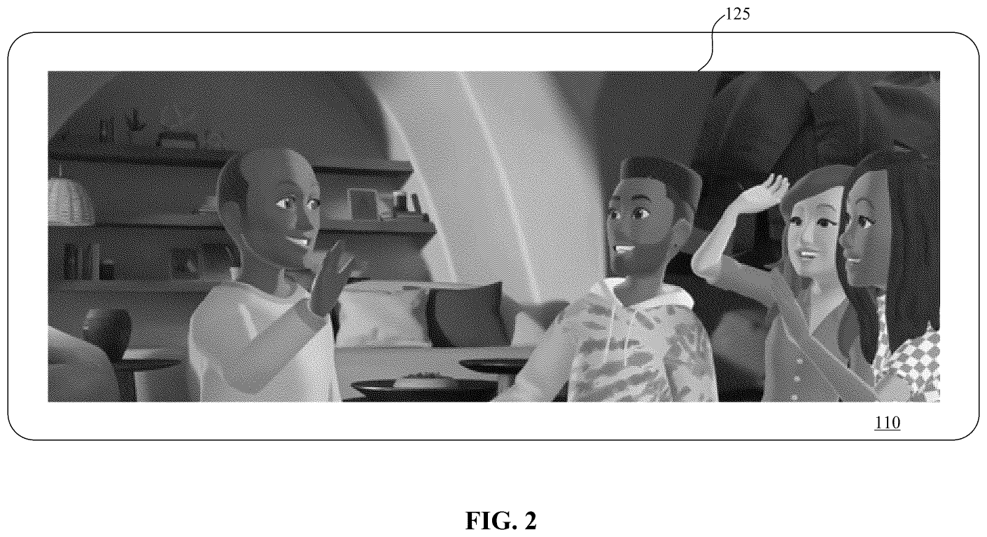

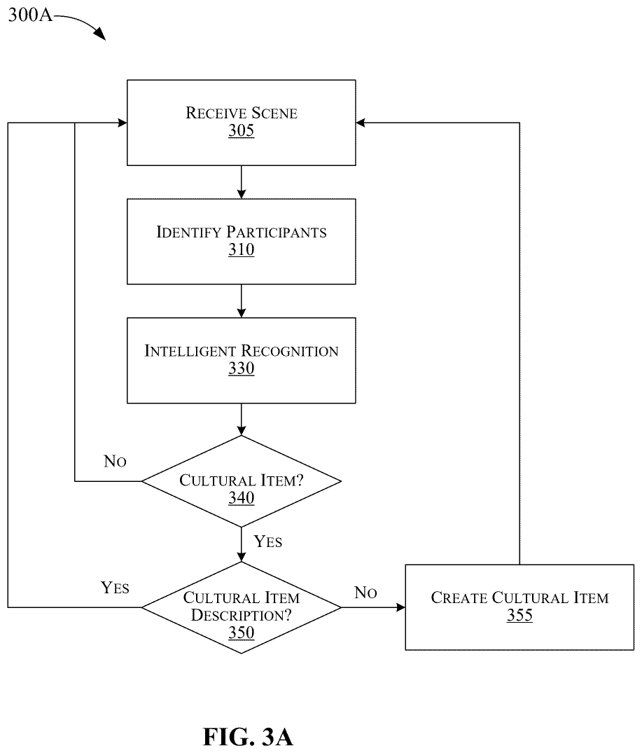

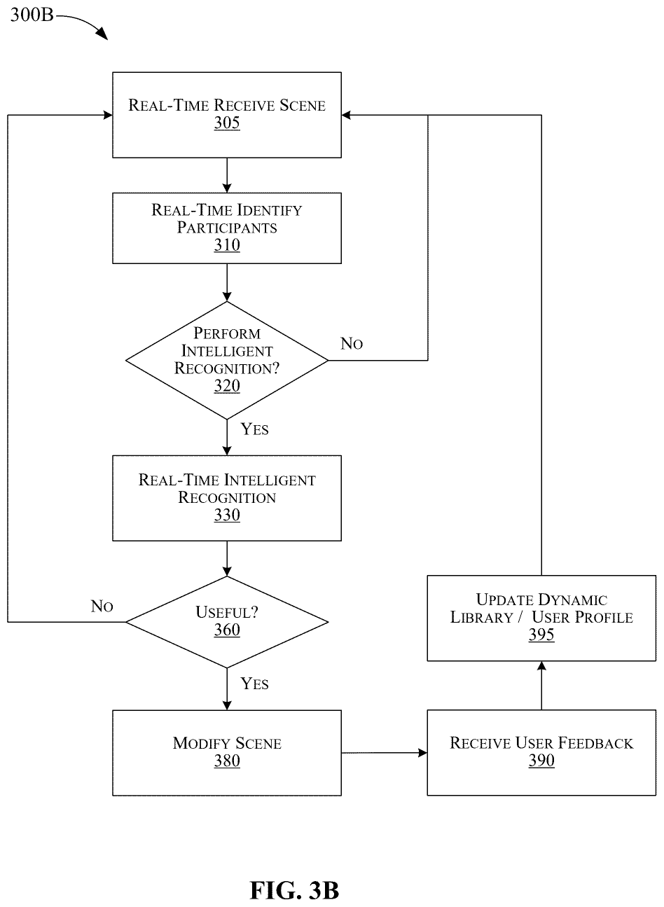

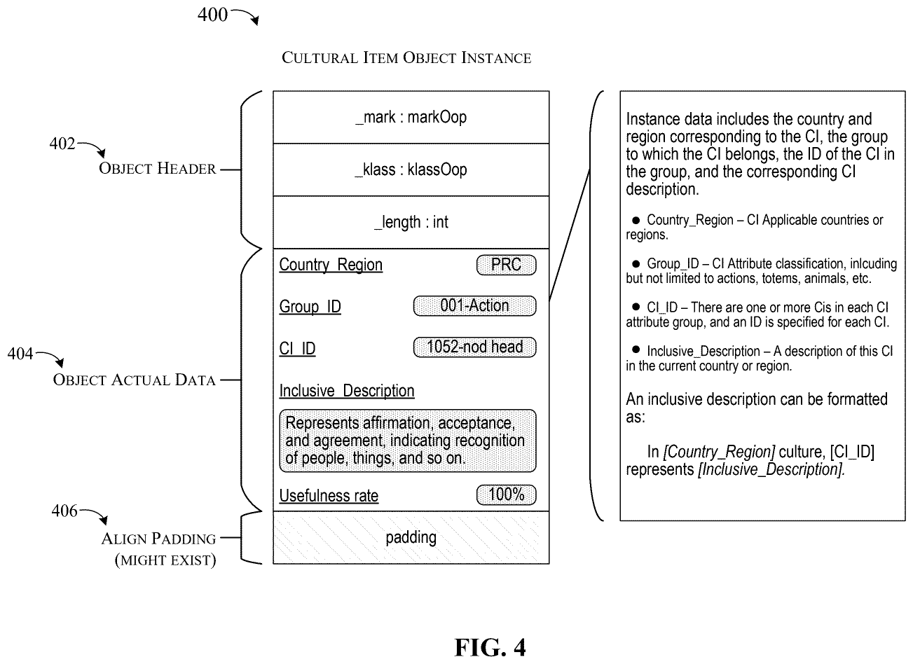

Reference is made to FIGS. 1A-1B and 3, which respectively illustrate a culturally-aware metaverse architecture 100 and methodology 300A, 300B for generating cultural item object instances 400 (see FIG. 4) and employing the same to generated a modified scene 185. The metaverse can be characterized with a new set of values such as copresence (i.e., the desire to be with others), collaboration (i.e., the need for interaction, voice, and co-creation), and connection (i.e., the need for persistent/omnipresent experiences). Whether in a work, educational, and/or social context, the metaverse can bring together individuals from many different geographic regions and/or cultures. One aspect of the metaverse is its capability of transmitting gestures (e.g., body movements) to others, which oftentimes have meanings that can differ from one culture to another. For example, in India, there are many types of head movements (called Shirobheda) for which different meanings are attached. One movement, the Parivahitam, involves shaking the head to the left and right and means harmony or agreement but could appear to a Western viewer as being similar to a head shake that means “no.” As another example, in China, pointing with a single finger (e.g., the index or pinkie finger) can be considered rude. These cultural differences can lead to communication and understanding misunderstandings when used in the metaverse.

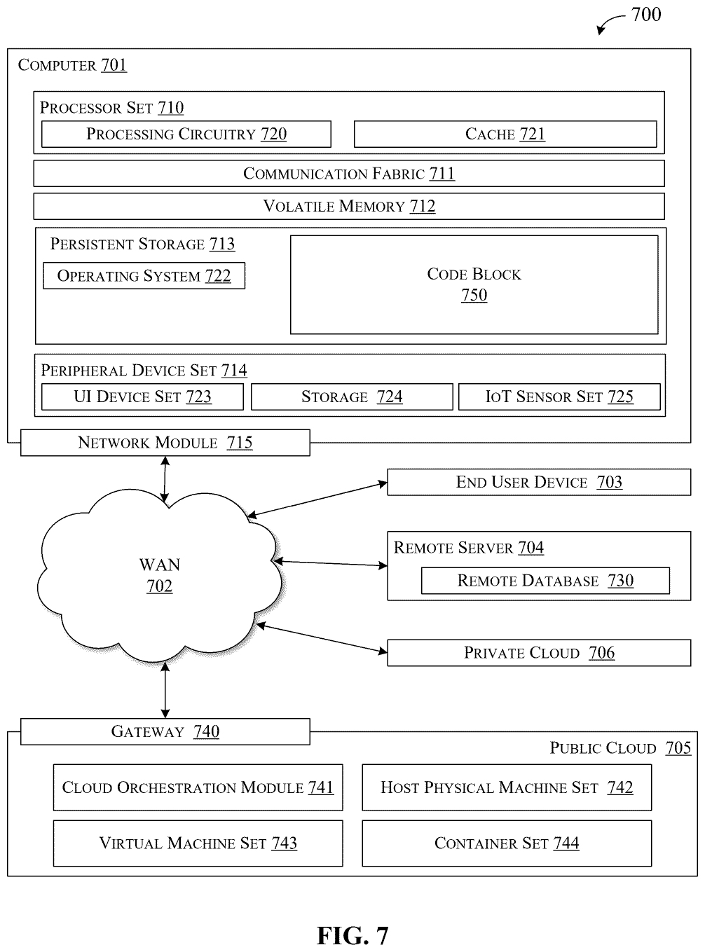

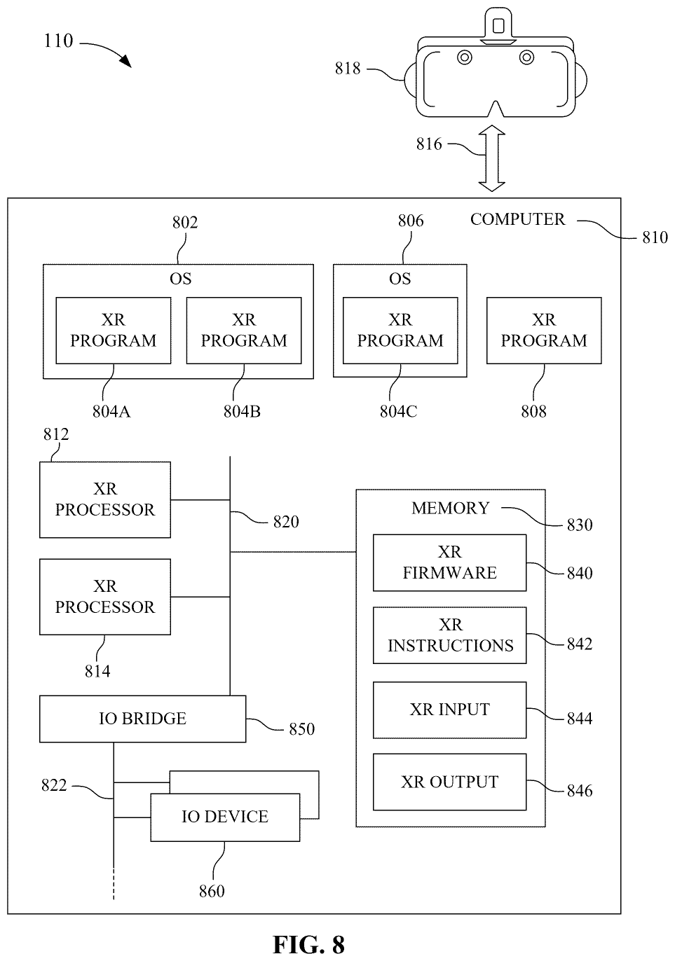

In general, the computer-implemented process 300B for generating a modified scene 185 uses a culturally-intelligent platform 120 having a dynamic library 120. A scene 125 associated with a particular user 105A is received in real-time by an interface 130 of the culturally-intelligent platform 120. The scene 125 is processed in real-time to identify participants 105A-C associated with the scene 125, and intelligent recognition is performed on the scene 125 by the intelligent recognition processor 140 to identify a cultural item (CI) within the scene 125 in real-time while using the dynamic library 145. The scene 125 is modified by the cultural processor 150 based upon a description of the identified CI within the dynamic library 145 to generate a modified scene 185 that includes the description. A usefulness of the identified CI can be determined, and an entry in the dynamic library 145 associated with the particular user 105A regarding the usefulness of the identified CI can be updated based upon the scene 125 being modified for the particular user 105A. The modified scene 185 is ultimately provided to the particular user 105A. The culturally-intelligent platform 120 and XR system 110 are respectively further described with regard to FIGS. 7 and 8.

Additionally, the usefulness can be determined based upon comparing a usefulness value for the identified CI to a threshold value. Also, the usefulness value can be based upon a base usefulness value for the identified CI, and decreases based upon an increased number of instances in which the scene 125 is modified based upon the identified CI. The identified CI can be a visual object displayed within the scene 125 or a human gesture displayed within the scene 125. The scene 125 is a computer data structure that represents a particular environment in which the users 105A-C interact. The intelligent recognition can employ machine learning to identify the CIs.

By employing the architecture 100 and methodology 300A, 300B of the present invention, cultural differences between different countries and regions can easily be reflected in the user's viewing process. If there are relevant audio or text descriptions in the environment or scene in the metaverse, focusing on the cultural differences that exist in different countries and regions can provide an improved experience for the users 105A-C. Additionally, the architecture 100 and methodology 300A, 300B can provide improved accessibility quality.

As used herein, a “scene” 125 is defined as a computer data structure that represents a particular environment in which users 105A-C of the metaverse interact either indirectly (e.g., by viewing the scene 125) or directly. The scene 125 can include, but is not limited to, information describing the virtual environment in which the users 105A-C interact, the users 105A-C themselves, gestures performed by the users 105A-C, and virtual objects (e.g., totems) with which users 105A-C can interact. A cultural item (CI), as used herein, can be a virtual object or a gesture that has a cultural connotation that may differ depending upon the cultural identity (e.g., country/region) of the user perceiving the CI. As used herein, a “gesture” is defined as a movement/action, associated with a particular user 105A, that is capable of being viewed by other users 105B-C within the virtual environment. A gesture can also include a perceptible representation (e.g., visual/audio/tactile) of speech/text generated by the particular user 105A. Although the present architecture 100 and methodology 300A, 300B is discussed with regard to the metaverse, the same approach can be employed for a particular user 105A watching content (e.g., a movie or video). Although this disclosure pertains to the collection of personal data (e.g., gestures), in certain embodiments and as further described below, users 105A-C opt-into the system 100. Additionally, the users 105A-C can be informed as to what personal data is being collected by the system 100 and how the personal data is being used. Also, any collected personal data may be encrypted while being used, and that a particular user 105A can opt-out of using the system 100 at any time. Additionally, if a particular user 105A opts-out, the personal data of the particular user 105A is deleted.

Referring to FIG. 1B, the culturally-intelligent platform 120 can include one or more functional components 130-170 and one or more storage systems 145, 155, 165 that can be used to implement the methodology 300A, 300B. Although the culturally-intelligent platform 120 is illustrated as including the functional components 130-170 and one or more storage systems 145, 155, 165, one or more of these components 130-170 and one or more storage systems 145, 155, 165 may be external to the culturally-intelligent platform 120. For example, the dynamic library/user profile 145, cultural library 155, training corpus 165, and machine learning engine 160 could be located in the cloud, as described in more detail with regard to FIG. 7.

Additionally, the culturally-intelligent platform 120 can be part of (or interact with a metaverse service platform 122 that supports the creation of the metaverse). The aforementioned scenes 125 can be received from this metaverse service platform 122 and/or directly from the XR systems 110. The metaverse service platform 122 is not limited to a particular type of technology/service, and can be any known provider that supports implementation of the metaverse.

Prior to performing the process 300B of generating a modified scene 185 illustrated in FIG. 3B, the cultural library 155 can be generated using the process 300A illustrated in FIG. 3A. The cultural library 155 includes data representing CIs in the form of cultural item (CI) object instances 400, which are further discussed with regard to FIG. 4. These CI object instances 400 are generated for each CI. The CI object instances 400 identify the CI using attribute information, in what circumstances the CI is applicable (e.g., a particular country/region), and a description of the CI that can be subsequently used to modify the scene 125 to generate the modified scene 185.

FIG. 4 illustrates an example of a CI object instance 400, which is a specific data structure associated with the CI. The CI object instance 400 can include an object header 402, object data 404, and optionally object padding 406. Object padding 406 is a known technique for adding empty bytes to a data structure to ensure proper alignment and promote efficient memory access. Although not limited to this specific information, the object data 404 can include: (i) country/region to which the CI object instance 400 applies, (ii) group ID that identifies the type of CI (e.g., gesture, action, totem, animal), (iii) CI-ID, which is a specific identifier associated with the CI object instance, and (iv) a description of the CI. The object data 404 can also include a measure of usefulness (e.g., usefulness value). The usefulness value can be used to determine, in operation 360, whether to modify the scene 125.

An example process 300A for generating the CI object instances 400 for the cultural library 155 is illustrated with regard to FIG. 3A. In 305, a scene 125 from the training corpus 165 is received, and in 310, participants 105A-C within that scene 125 are identified similar to the manner discussed with regard to operation 310 in FIG. 3B. The identification of the participants 105A-C can also include an identification of cultural identity (e.g., country/region) of the participants 105A-C. In 330, an intelligent recognition operation 330 is performed on the scene 125 to identify CIs within the scene 125. In 340, a determination is made whether one or more CIs exists within the scene 125. If not, the process 300A returns to operation 305 to receive and subsequently analyze another scene 125. However, if a CI exists, in 350, a determination is made whether a CI description (e.g., the CI object instance 400) exists for the CI. If the CI description already exists, the process 300A returns to operation 305 to receive and subsequently analyze another scene 125. However, if a CI object instance 400 does not exist for a particular CI, then the CI object instance 400 is generated in operation 355.

The CI object instances 400 stored within the cultural library 155 are not limited in the manner in which they are generated. However, in certain aspects the CI object instances 400 stored within cultural library 155 are generated using a machine learning engine 160 in conjunction with the training corpus 165 of prior scenes (e.g., videos). Many different artificial intelligence approaches can be used to train the machine learning engine 160 and generate a library of objects, and the culturally-intelligent platform 120 is not limited as to a particular approach. For example, the machine learning engine 160 can employ supervised learning where a human can annotate images derived from the training corpus 165. Additionally, a deep learning approach using a convolution neural network (CNN) can be employed. Regardless of the approach employed, the cultural library 155 is populated with CI object instances 400 that will subsequently be used to identify CIs within real-time received scenes 125, as further described in FIG. 3B.

The dynamic library/user profile 145 is a storage system that can be used to store information regarding each user 105A-C. Although described separately, the dynamic library/user profile 145 can be combined together. The user profile 145 can include information that establishes a cultural identity of a particular participant 105A. For example, the user profile 145 may indicate that the particular participant 105A identifies with a particular cultural region or location. Additionally, the user profile 145 for a particular participant 105A may also include an indicator (e.g., ON or OFF) whether the participant 105A has chosen to opt into use of the culturally-intelligent platform 120 to generate a modified scene 185. The user profile 145 can be generated by the user and/or automatically generated based upon information associated with the user (e.g., a particular IP address may indicate a user is from a particular geographic region).

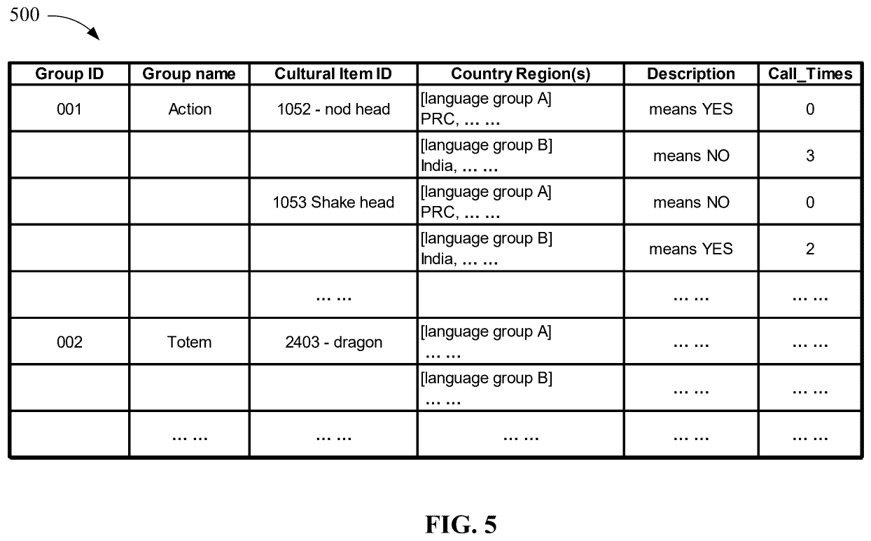

An example of the data contained within the dynamic library 145 is illustrated with regard to FIG. 5. As illustrated, the dynamic library 145 can include, for each user 105A-C, data indicating what CI each user 105A-C has been exposed to in addition to information pertaining to the CI (e.g., the CI object instance 400) and information that can be used to determine a usefulness value for the CI (e.g., the number of times that the CI has been called).

Referring specifically to FIG. 3B, the process 300B of generating a modified scene 185 is further described. In 305, a scene 125 is received, in real-time, by the interface 130 of the culturally-intelligent platform 120. In 310, participants 105A-C in the scene 125 are identified in real-time by the intelligent recognition processor 140. Identifying participants 105A-C of a scene 125 in the metaverse is a known technology, and any technique so capable is acceptable for use with the culturally-intelligent platform 120. The participants 105A-C can be users who are themselves represented in the scene 125 (e.g., by using an avatar). Additionally, the participants 105A-C can be users who are just viewing the scene 125.

In 320, once the identities of the participants in the scene 125 are established, the intelligent recognition processor 140 can optionally make a determination as whether to perform intelligent recognition of CIs within the current scene 125. This determination can be performed using information stored within the user profile 145 of each of the participants 105A-C.

Based upon the information stored with the user profile 145, a determination is made whether to employ the culturally-intelligent platform 120 to perform intelligent recognition of CIs within the current scene 125 and subsequently generate a modified scene 185. For example, if all of the participants 105A-C are from the same geographic region and have the same cultural identity, the culturally-intelligent platform 120 can determine that there is no need to generate a modified scene 185. Alternatively, if all of the participants 105A-C have chosen to opt out of using the culturally-intelligent platform 120, then the process 300B returns to operation 305 to perform the real-time receipt of a new scene 125 and identification of participants in that scene 125 in operation 310. However, if the participants 105A-C have different cultural identities and one or more of the participants 105A-C have opted into using the culturally-intelligent platform 120 to generate a modified scene 185, the process 300B proceeds to the real-time intelligent recognition operation 330.

In 330, based upon the determination in 320, intelligent recognition of the current scene 125 is performed in real-time by the intelligent recognition processor 140 of the culturally-intelligent platform 120 in conjunction with the machine learning engine 160 and the cultural library 155. In other words, as the scene 125 changes and new CIs are possibly displayed, the intelligent recognition processor 140 can continually monitor, in real-time, the scene 125 and recognize, using the CI object instances 400 stored within the cultural library 155, any new CIs as they appear within the scene 125. The manner in which the intelligent recognition processor 140 operates is not limited as to a particular approach.

For example, the intelligent recognition processor 140 can employ known technology (e.g., video object detection (VOD)) to identify objects within the scene 125. Although not limited in this manner, the intelligent recognition processor 140 can use the machine learning engine 160 along with the information contained within the cultural library 155 to perform the identification of the CIs within the scene 125. As discussed above with regard to the process 300A of generating the cultural library 155, the machine learning engine 160 can use any number of known artificial intelligence techniques to identify CIs. Consequently, the intelligent recognition processor 140 can be configured to identify, amongst all objects identified within the scene 125, specific CIs.

Additionally, the intelligent recognition processor 140 can be configured to identify CIs in the form of human actions, for example, by performing human post estimation, which includes extracting human body key points from the scene 125 while using lines and/or skeletons to represent human postures. According to changes in the identified human postures, each frame or segment in the scene 125 can be divided into different action categories (e.g., head movement, hand movement). Using the different action categories, a particular human action, as a CI, can be identified. Many other approaches to identifying human actions from a video are known, and the intelligent recognition processor 140 is not limited as to a particular approach so capable.

In 360, a determination is made as to the usefulness associated with a particular CI. As discussed above, an initial usefulness value can be associated with each particular CI and modified based upon user information associated with a particular user 105A. In particular, the usefulness value can be compared to a predetermined threshold value (either preset or set by the particular user 105A), and based upon that comparison, a determination can be made whether to modify the scene 125. For example, if the threshold value is 30% and the usefulness value is determined to be 40%, then a determination can be made to modify the scene 125.

There are multiple possible approaches for determining the usefulness value, and the culturally-intelligent platform 120 is not limited as to a particular approach. One possible approach would involve assigning a base usefulness value to a particular CI that can be modified based upon how many times a particular description of the CI has been presented to a user 105A-C. A data structure 500 associated with a particular user, as illustrated in FIG. 5, for example, can include a number of times (e.g., Call_Times) the particular description of a CI has been presented to the particular user 105A The number of calls can then be modified by some predetermined value (either preset or set by the particular user 105A) and used to modify the base usefulness value. For example, if the base usefulness value is 100%, the number of calls is 3, and the predetermined value is 15%, then the modified usefulness value is (100%−(3×$15%)) or 55%, which can then be compared to the threshold value. This approach is based upon an assumption that the utility of a particular description of the CI is reduced the more times a particular user 105A views the description of the CI.

In another approach, the threshold value can be based upon user feedback 175 provided in operation 390. For example, after the scene 125 was modified to include a description of the CI, the feedback processor 170 of the culturally-intelligent platform 120 can request feedback 175 from the particular user 105A. Although not limited in this manner, the feedback 175 can be in the form of providing a ranking for the description of between 1 to 5 stars. This feedback information can be stored within the dynamic library/user profile 145 in operation 395. By way of example, if the threshold value is 40%, the culturally-intelligent platform 120 can subsequently determine, in operation 370, that modification of the scene 125 to include the description will not be performed.

In yet another approach, the culturally-intelligent platform 120 can causes the XR system 110 associated with the particular user 105A to prompt, in real-time, the user 105A as to whether a description of the CI is desired by the particular user 105A. The user 105A then has the option to receive (or not receive) a description of the CI as part of a modified scene 185.

The real-time intelligent recognition operation 330 and usefulness determination operation 360 can be performed until all CIs within the scene 125 have been identified and usefulness determined. If no CIs were determined to be useful in 360, the process 300B returns to operation 305 to continue receipt real-time receipt and subsequent analysis of a new scene 125. Otherwise, the process 300B proceeds to operation 380 to modify the scene 125 to generate a modified scene 185.

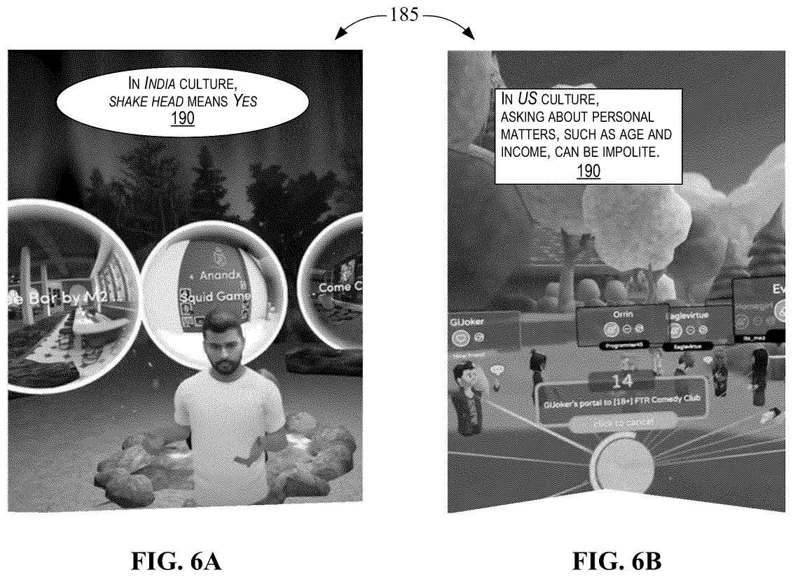

In 380, the cultural processor 150 of the culturally-intelligent platform 120 modifies the scene 125 to generate a modified scene 185 that will be subsequently provided to the particular user 105A. The manner in which the modified scene 185 is not limited as to a particular approach. For example, the modified scene 185 can include both the original scene 125 and the description of one or more CIs that met the usefulness determination in operation 360. In another example, the modified scene 185 can include just an identification of the one or more CIs within the scene 125 as well as the description of the CIs to be subsequently added to the scene 125. This information can be transmitted and subsequently combined with the original scene 125 by the XR system 110 and/or metaverse service platform 122 and presented to the particular user 105A. Examples of modified scenes 185 are illustrated in FIGS. 6A and 6B. In each instance, the modified scenes 185 can include visual representations 190 of the description of the CI. Although not illustrated, the modification to the original scene 125 can include, additionally or alternatively, modifications to the CI themselves. For example, a particularly-offensive CI could be blurred and/or modified to be more culturally sensitive. For example, in Chinese cultural, gesturing with a single finger (e.g., a little finger) can be considered offensive and that gesture (i.e., CI) could be replaced with a whole-hand gesture, which is more culturally-accepted. The modified scene 185, once generated, can then be forwarded to the metaverse service platform 122 and/or the XR systems 110 of the particular user 105A.

In 390, after the scene 125 has been modified to generate a modified scene 185, the particular user 105A can optionally be provided with an opportunity to provide feedback 175 to the culturally-intelligent platform 120, as already discussed above. Many different approaches can be used, and the culturally-intelligent platform 120 is not limited as to a particular approach. For example, the culturally-intelligent platform 120 can use the feedback processor 170 to request and/or receive feedback 175 as to the modified scene 185 from the XR system 110 associated with the particular user 105A. This feedback 175 can include a rating of the usefulness of the description of the CI. The feedback 175, however, is not limited in this manner. The feedback 175 can also include suggested modifications to the description of the CI.

In 395, the dynamic library/user profile 145 can be updated. For example, the number of times a particular CI description has been called by a particular user 105A can be modified. Additionally, based upon the feedback 175, the usefulness value of a particular CI description to a particular user 105A can be modified. The process 300B then returns to operation 305 to continue receipt real-time receipt and subsequent analysis of a new scene 125.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the terms “real-time” or “real time” mean a level of processing responsiveness that a user or system senses as sufficiently immediate for a particular process or determination to be made, or that enables the processor to keep up with some external process.

As defined herein, the term “automatically” means without user intervention.

Referring to FIG. 7, computing environment 700 contains an example of an environment for the execution of at least some of the computer code involved in performing the inventive methods, such as code block 750 for implementing the operations of the culturally-intelligent platform 120. Computing environment 700 includes, for example, computer 701, wide area network (WAN) 702, end user device (EUD) 703, remote server 704, public cloud 705, and private cloud 706. In certain aspects, computer 701 includes processor set 710 (including processing circuitry 720 and cache 721), communication fabric 711, volatile memory 712, persistent storage 713 (including operating system 722 and method code block 750), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. However, to simplify this presentation of computing environment 700, detailed discussion is focused on a single computer, specifically computer 701. Computer 701 may or may not be located in a cloud, even though it is not shown in a cloud in FIG. 7 except to any extent as may be affirmatively indicated.

Processor set 710 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In certain computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in code block 750 in persistent storage 713.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 711 is the signal conduction paths that allow the various components of computer 701 to communicate with each other. Typically, this communication fabric 711 is made of switches and electrically conductive paths, such as the switches and electrically conductive paths that make up busses, bridges, physical input/output ports and the like. Other types of signal communication paths may be used for the communication fabric 711, such as fiber optic communication paths and/or wireless communication paths.

Volatile memory 712 is any type of volatile memory now known or to be developed in the future. Examples include dynamic type random access memory (RAM) or static type RAM. Typically, the volatile memory 712 is characterized by random access, but this is not required unless affirmatively indicated. In computer 701, the volatile memory 712 is located in a single package and is internal to computer 701. In addition to alternatively, the volatile memory 712 may be distributed over multiple packages and/or located externally with respect to computer 701.

Persistent storage 713 is any form of non-volatile storage for computers that is now known or to be developed in the future. The non-volatility of the persistent storage 713 means that the stored data is maintained regardless of whether power is being supplied to computer 701 and/or directly to persistent storage 713. Persistent storage 713 may be a read only memory (ROM), but typically at least a portion of the persistent storage 713 allows writing of data, deletion of data and re-writing of data. Some familiar forms of persistent storage 713 include magnetic disks and solid state storage devices. Operating system 722 may take several forms, such as various known proprietary operating systems or open source Portable Operating System Interface type operating systems that employ a kernel. The code included in code block 750 typically includes at least some of the computer code involved in performing the inventive methods.

Peripheral device set 714 includes the set of peripheral devices for computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some aspects, storage 724 may take the form of a quantum computing storage device for storing data in the form of qubits. In aspects where computer 701 is required to have a large amount of storage (for example, where computer 701 locally stores and manages a large database) then this storage 724 may be provided by peripheral storage devices designed for storing very large amounts of data, such as a storage area network (SAN) that is shared by multiple, geographically distributed computers. Internet-of-Things (IoT) sensor set 725 is made up of sensors that can be used in IoT applications. For example, one sensor may be a thermometer and another sensor may be a motion detector.

Network module 715 is the collection of computer software, hardware, and firmware that allows computer 701 to communicate with other computers through a Wide Area Network (WAN) 702. Network module 715 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 715 are performed on the same physical hardware device. In other aspects (for example, aspects that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any Wide Area Network (for example, the internet) capable of communicating computer data over non-local distances by any technology for communicating computer data, now known or to be developed in the future. In some aspects, the WAN 702 ay be replaced and/or supplemented by local area networks (LANs) designed to communicate data between devices located in a local area, such as a Wi-Fi network. The WAN 702 and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In certain aspects, EUD 703 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704. As defined herein, the term “server” means a data processing system configured to share services with one or more other data processing systems.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705.

The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other aspects, a private cloud 706 may be disconnected from the internet entirely (e.g., WAN 702) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 705 and private cloud 706 are both part of a larger hybrid cloud.

FIG. 8 is an example of an example of the XR system 110 previously illustrated in FIG. 1A. As shown, the XR system 110 includes an audio/video (A/V) headset 818, as referred to as smart glasses, augmented reality device or an extended reality headset. The XR system 300 also includes a XR computer 810. Although illustrated as being separate from the headset 818, one or more portions of the XR computer 810 can be embedded within the headset 818. The example XR system 300, and/or components thereof, are not intended to be necessarily limiting as to the present disclosure.

The XR computer 810 can include one or more XR processors 812, 814, which can be a single processor or a multi-threaded processor, a general purpose or a special purpose processor, a co-processor, or any of a variety of processing devices that can execute computing instructions. If one or more portions of the XR computer 810 are separate from the headset 818, interface 816 couples XR computer 810 to the headset 818. The XR processors 812, 814 can be connected by memory interface 820 to memory 830, which can be a cache memory, a main memory, a flash memory, or a combination of these or other varieties of electronic hardware devices capable of storing information and, optionally, making the information, or locations storing the information within the memory, accessible to the XR processors 812, 814. The XR computer 810 can include an IO bridge 350, which can be connected to the memory 830 and/or XR processors 812, 814 by a memory interface 320. The IO bridge 850 can interface with the memory interface 820 to IO devices, such as IO device 860. The interface 822 can be any of a variety of IO interfaces, such as a PCI-Express (PCI-E) bus, and IO bridge 850 can, correspondingly, be a PCI-E bridge, and IO device 860 can be a PCI-E device (e.g., a disk drive), or PCI-E adapter (e.g., a network interface card, or a disk adapter). The IO devices 860-an be any of a variety of peripheral IO devices or IO adapters connecting to peripheral IO devices. For example, IO device 860 can be a graphic card, keyboard or other input device, a hard drive or other storage device, a network interface card, etc. Additionally, the XR system 110 can communicate with other devices, such as the culturally-intelligent platform 120 illustrated in FIGS. 1A-B, using the IO device 860.

The XR computer 810 can include instructions executable by one or more of the XR processors (or, processing elements, such as threads of a XR processor) 812, 814. As illustrated, XR computer 810 includes a plurality of programs, such as XR programs 804A, 804B, 804C (collectively, “XR programs 804”), and 808, and operating systems OS 802 and 806. The XR programs 804 can be, for example, an application program (e.g., an application for generating XR expressions), a function of an operating system (e.g., a device driver capable of operating an IO device, such as 860), or a utility or built-in function of a computer, such as 810. A XR program 804 can be a hypervisor, and the hypervisor can, for example, manage sharing resources of the computer (e.g., a XR processor or regions of a memory, or access to an IO device) among a plurality of programs or OSes. A XR program 804 can be a program that embodies the methods, or portions thereof, of the disclosure. For example, a XR program 804 can be a program that executes on a XR processor 812, 814 of XR computer 810 to perform method 300 of FIG. 3, or portions and/or modifications thereof, within the scope of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method by a culturally-intelligent platform including a dynamic library for generating a modified scene, comprising:
receiving, in real-time, a scene associated with a particular user;
processing, in real-time, the scene to identify participants associated with the scene;
performing, in real-time and using the dynamic library, intelligent recognition on the scene to identify a cultural item within the scene; and
modifying the scene, based upon a description of the identified cultural item within the dynamic library, to generate a modified scene that includes the description.

2. The method of claim 1, further comprising:
determining a usefulness of the identified cultural item; and
updating an entry in the dynamic library associated with the particular user regarding the usefulness of the identified cultural item based upon the scene being modified for the particular user.

3. The method of claim 2, wherein
the usefulness is determined based upon comparing a usefulness value for the identified cultural item to a threshold value.

4. The method of claim 3, wherein
the usefulness value is
based upon a base usefulness value for the identified cultural item, and
decreases based upon an increased number of instances in which the scene is modified based upon the identified cultural item.

5. The method of claim 1, wherein
the identified cultural item is a visual object displayed within the scene.

6. The method of claim 1, wherein
the identified cultural item is a human gesture displayed within the scene.

7. The method of claim 1, wherein
the scene is a computer data structure that represents a particular environment in which the users interact.

8. The method of claim 1, wherein
the intelligent recognition employs machine learning to identify the cultural items.

9. A computer hardware system including a culturally-intelligent platform having a dynamic library for generating a modified scene, comprising:
a hardware processor configured to perform the following executable operations:
receiving, in real-time, a scene associated with a particular user;
processing, in real-time, the scene to identify participants associated with the scene;
performing, in real-time and using the dynamic library, intelligent recognition on the scene to identify a cultural item within the scene; and
modifying the scene, based upon a description of the identified cultural item within the dynamic library, to generate a modified scene that includes the description.

10. The system of claim 9, wherein the hardware processor is further configured to perform:
determining a usefulness of the identified cultural item; and
updating an entry in the dynamic library associated with the particular user regarding the usefulness of the identified cultural item based upon the scene being modified for the particular user.

11. The system of claim 10, wherein
the usefulness is determined based upon comparing a usefulness value for the identified cultural item to a threshold value.

12. The system of claim 11, wherein
the usefulness value is
based upon a base usefulness value for the identified cultural item, and
decreases based upon an increased number of instances in which the scene is modified based upon the identified cultural item.

13. The system of claim 9, wherein
the identified cultural item is a visual object displayed within the scene.

14. The system of claim 9, wherein
the identified cultural item is a human gesture displayed within the scene.

15. The system of claim 9, wherein
the scene is a computer data structure that represents a particular environment in which the users interact.

16. The system of claim 9, wherein
the intelligent recognition employs machine learning to identify the cultural items.

17. A computer program product, comprising:
a computer readable storage medium having stored therein program code for generating a modified scene,
the program code, which when executed by a computer hardware system including a culturally-intelligent platform having a dynamic library, causes the computer hardware system to perform:
receiving, in real-time, a scene associated with a particular user;
processing, in real-time, the scene to identify participants associated with the scene;
performing, in real-time and using the dynamic library, intelligent recognition on the scene to identify a cultural item within the scene; and
modifying the scene, based upon a description of the identified cultural item within the dynamic library, to generate a modified scene that includes the description.

18. The computer program product of claim 17, wherein the program code further causes the computer hardware system to perform:
determining a usefulness of the identified cultural item; and
updating an entry in the dynamic library associated with the particular user regarding the usefulness of the identified cultural item based upon the scene being modified for the particular user.

19. The computer program product of claim 18, wherein
the usefulness is determined based upon comparing a usefulness value for the identified cultural item to a threshold value.

20. The computer program product of claim 19, wherein
the usefulness value is
based upon a base usefulness value for the identified cultural item, and
decreases based upon an increased number of instances in which the scene is modified based upon the identified cultural item.
